(19) United States
(12) Patent Application Publication
(10) Pub. No.: US 2021/0207552 A1
(43) Pub. Date: Jul. 8, 2021

(54) FUEL PUMP CONTROL SYSTEM AND METHOD FOR DETECTING INDICATION OF ABNORMALITY IN FUEL PUMP

(71) Applicant: DENSO CORPORATION, Kariya-city (JP)

(72) Inventors: Tomoaki NAKANO, Kariya-city (JP); Yuuji HIDAKA, Kariya-city (JP); Hirokazu TOYODA, Kariya-city (JP)

(21) Appl. No.: 17/205,365

(22) Filed: Mar. 18, 2021

Related U.S. Application Data
(63) Continuation of application No. PCT/JP2019/032030, filed on Aug. 15, 2019.

(30) Foreign Application Priority Data
Sep. 20, 2018 (JP) 2018-175556

(51) Int. Cl. F02D 41/22; F02D 41/30

(52) U.S. Cl. CPC F02D 41/221; F02D 41/3082; F02D 2200/0606; F02D 2200/0602; F02D 2041/224

(57) ABSTRACT

A pump control unit controls a fuel pump based on a control target value of an engine. A pump characteristic detection unit acquires a pump characteristic value among pump characteristic values, which indicate an operating state of a fuel pump and include a supplied current to the fuel pump, an applied voltage to the fuel pump, a generated voltage of the fuel pump, and a rotation speed of the fuel pump. A pump characteristic storage unit stores the acquired pump characteristic value together with the control target value. A determination threshold set unit sets a determination threshold value by using at least one of the stored pump characteristic value, the control target value, and a combination of at least two of the control target values. A fuel pump deterioration determination unit determines deterioration of the fuel pump by using the stored pump characteristic value and the determination threshold value.

### CROSS REFERENCE TO RELATED APPLICATION

The present application is a continuation application of International Patent Application No. PCT/JP2019/032030 filed on Aug. 15, 2019, which designated the U. S. and claims the benefit of priority from Japanese Patent Application No. 2018-175556 filed on Sep. 20, 2018. The entire disclosures of all of the above applications are incorporated herein by reference.

### TECHNICAL FIELD

The present disclosure relates to a fuel pump control system and a method for detecting indication of abnormality in fuel pump.

### BACKGROUND

Conventionally, a fuel pump has been provided to a vehicle to feed fuel.

### SUMMARY

According to an aspect of the present disclosure, a fuel pump control system is provided for supplying fuel from a fuel tank to an internal combustion engine.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an explanatory diagram showing a schematic configuration of a vehicle;

FIG. 2 is an explanatory diagram showing a schematic configuration of a fuel pump control system;

FIG. 3 is a control flowchart of a fuel pump;

FIG. 4 is a feedback control flowchart of fuel pressure;

FIG. 5 is a flowchart for determining an indication of an abnormality of the fuel pump;

FIG. 6 is an example of a graph showing a determination threshold value for determination of the indication of an abnormality and an example of the determination;

FIG. 7 is an example of a graph showing an example of the determination of the indication of an abnormality;

FIG. 8 is an example of a graph showing the determination threshold value for the determination of the indication of an abnormality and an example of the determination;

FIG. 9 is an example of a graph showing the determination threshold value for the determination of the indication of an abnormality and an example of the determination; and

FIG. 10 is an example of a graph showing the determination threshold value for the determination of the indication of an abnormality and an example of the determination.

### DETAILED DESCRIPTION

Hereinafter, examples of the present disclosure will be described.

According to an example of the present disclosure, a device is provided to detect an indication of an abnormality in an in-vehicle electronic component, such as a fuel pump.

According to an example of the present disclosure, a device may detect an indication of an abnormality in an in-vehicle electronic component when a number of occurrences of abnormality factor events in an external situation, which affects the in-vehicle electronic component and potentially causes an abnormality in the in-vehicle electronic component, exceeds a threshold value for the detection of the indication. The device may change the threshold value for the detection such that an abnormality of the in-vehicle electronic component can be easily detected when the indication of abnormality in the in-vehicle electronic component is detected.

The operating state of the fuel pump may change significantly depending on the usage condition of the vehicle. Therefore, when acquired fuel pump characteristics show the indication of an abnormality in the fuel pump, it would be hardly determinable whether the indication has been caused by abnormality in the operation of the fuel pump itself or whether the operation of the fuel pump itself is normal, but the indication has been caused by a change in the operating state of the fuel pump. Therefore, it is required to detect an indication of an abnormality in a fuel pump regardless of the usage condition of the vehicle.

According to an example of the present disclosure, a fuel pump control system for supplying fuel from a fuel tank to an internal combustion engine is provided. This fuel pump control system includes: a pump control unit configured to control the fuel pump based on a control target value of at least one target item of the internal combustion engine; a pump characteristic detection unit configured to acquire a pump characteristic value, which is required to determine deterioration of the fuel pump, among pump characteristic values, which indicate an operating state of the fuel pump and include at least one of a supplied current to the fuel pump, an applied voltage to the fuel pump, a generated voltage of the fuel pump, and a rotation speed of the fuel pump; a pump characteristic storage unit configured to store, together with the control target value, the pump characteristic value acquired by the pump characteristic detection unit; a determination threshold set unit configured to set a determination threshold value, which is for determining deterioration of the fuel pump, by using at least one of the stored pump characteristic value, the control target value, and a combination of at least two of the control target values; and a fuel pump deterioration determination unit configured to determine deterioration of the fuel pump by using the pump characteristic value stored in the pump characteristic storage unit and the determination threshold value.

This configuration detects an indication of an abnormality in the fuel pump when the pump characteristic value of the fuel pump becomes out of the determination threshold value that is set for the control target value of the target item. Therefore, even in a case where the control target value of the target item changes depending on the usage and the condition of the vehicle, an indication of an abnormality in fuel pump can be detected.

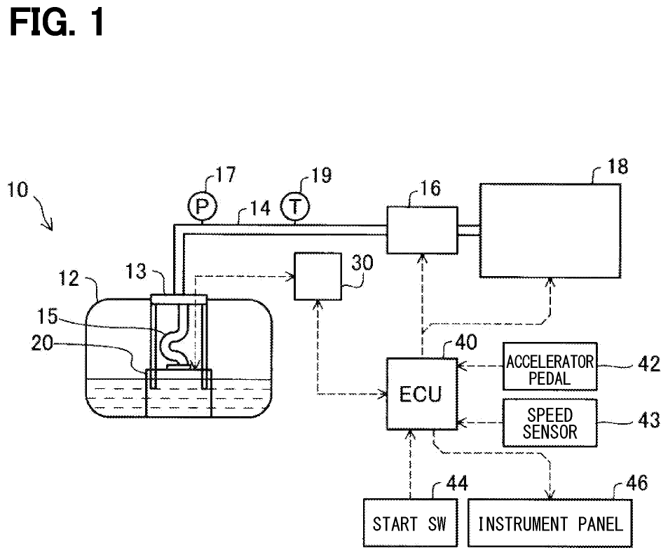

A vehicle 10 shown in FIG. 1 burns fuel with an engine 18 which is an internal combustion engine to obtain power, thereby to travel. A control unit 40 (described as “ECU 40” in FIG. 1) computes target values of a fuel flow amount and a fuel pressure (also referred to as “fuel pressure”) required for the engine 18 based on an amount of depression of an accelerator pedal 42 of the vehicle 10 and a speed of the vehicle 10 acquired from a speed sensor 43, and controls a pump control unit 31 and an injector 16 to supply fuel to the engine 18. A fuel pump 20 is connected to a lid 13 through a flexible pipe 15 and is further connected to a fuel supply pipe 14. The fuel pump 20 draws up fuel in a fuel tank 12 according to a command from the pump control unit 31 and supplies the fuel to the engine 18 through the fuel supply pipe 14 and the injector 16. A pressure sensor 17 is mounted on the fuel supply pipe 14 and detects a pressure in the fuel pipe. A start switch 44 (also referred to as a start switch 44 and shown as “start SW44” in FIG. 1) is a switch for instructing start and stop of the vehicle 10. An instrument panel 46 is a device to provide information on the vehicle 10 to the driver. For example, the instrument panel 46 indicates a speed of the vehicle 10, a remaining amount of fuel, an abnormality in the vehicle equipment, and the like and notifies the driver of the information.

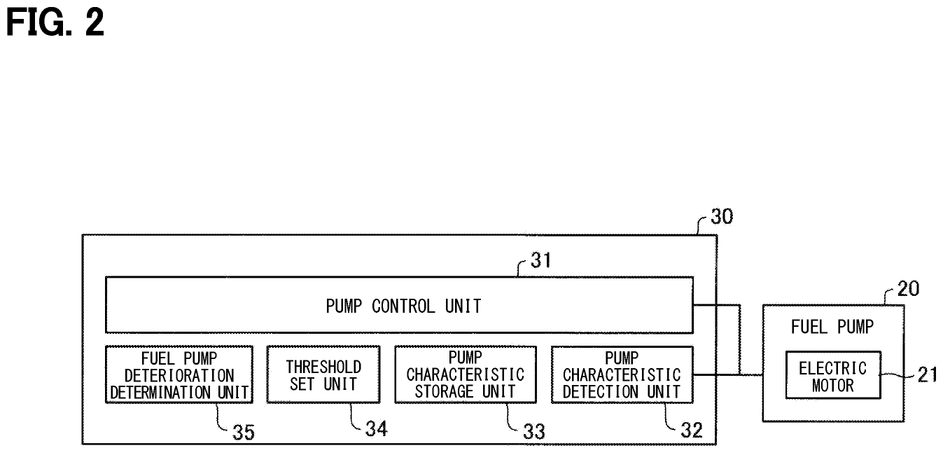

As shown in FIG. 2, a fuel pump control system unit 30 includes the pump control unit 31, a pump characteristic detection unit 32, a pump characteristic storage unit 33, a determination threshold set unit 34, and a fuel pump deterioration determination unit 35. The pump control unit 31 drives an electric motor 21 so that a deviation between a target fuel pressure and an actual fuel pressure obtained from the pressure sensor 17 is eliminated. The signal to drive the fuel pump 20 is output as a target voltage, which correlates with a flow amount/pressure characteristics of the fuel pump 20, or is output as each phase voltage, which corresponds to a target rotation speed of the fuel pump 20. The fuel pump 20 draws fuel in the fuel tank 12 (FIG. 1) by driving the electric motor 21 and feeds the fuel to the fuel supply pipe 14.

The pump characteristic detection unit 32 acquires a voltage and a current as a result of the electric motor 21 being actually driven at the target voltage and the rotation speed as a result of the electric motor 21 being actually driven. The voltage, the current, and the rotation speed may be detected by using various sensors or may be detected by providing a detection circuit to the ECU or the fuel pump control system unit 30. The applied voltage and the supplied current to the electric motor 21 as a result of the fuel pump 20 being actually driven and the rotation speed of the fuel pump 20 are pump characteristics indicating the operating state of the fuel pump 20, and those values are referred to as “pump characteristic values”. The pump characteristic storage unit 33 stores the pump characteristic values indicating an operating state of the fuel pump 20 together with a fuel flow amount, a fuel pressure, and a temperature. The fuel pump control system unit 30 may not be provided, and the control unit 40 may execute the function of the fuel pump control system unit 30. The temperature of fuel may be acquired directly from a fuel temperature sensor 19 attached to the fuel supply pipe 14. The fuel temperature sensor 19 may be attached not to the pipe and may be attached to the inside of the tank, the engine, or the like. Further, the temperature of fuel is also affected by the outside air temperature and is substantially the same as the outside air temperature. Therefore, the outside air temperature may be measured, and the fuel temperature may be estimated from the outside air temperature by using another device. Further, a configuration may be employable not to measure and store the temperature of fuel.

The determination threshold set unit 34 sets a determination threshold value for determining deterioration of the fuel pump 20. The method to set the determination threshold value will be described later. The fuel pump deterioration determination unit 35 determines the deterioration of the fuel pump 20 by using the pump characteristic value and the determination threshold value, which are stored in the pump characteristic storage unit 33, and detects whether or not an indication of an abnormality arises in the fuel pump 20.

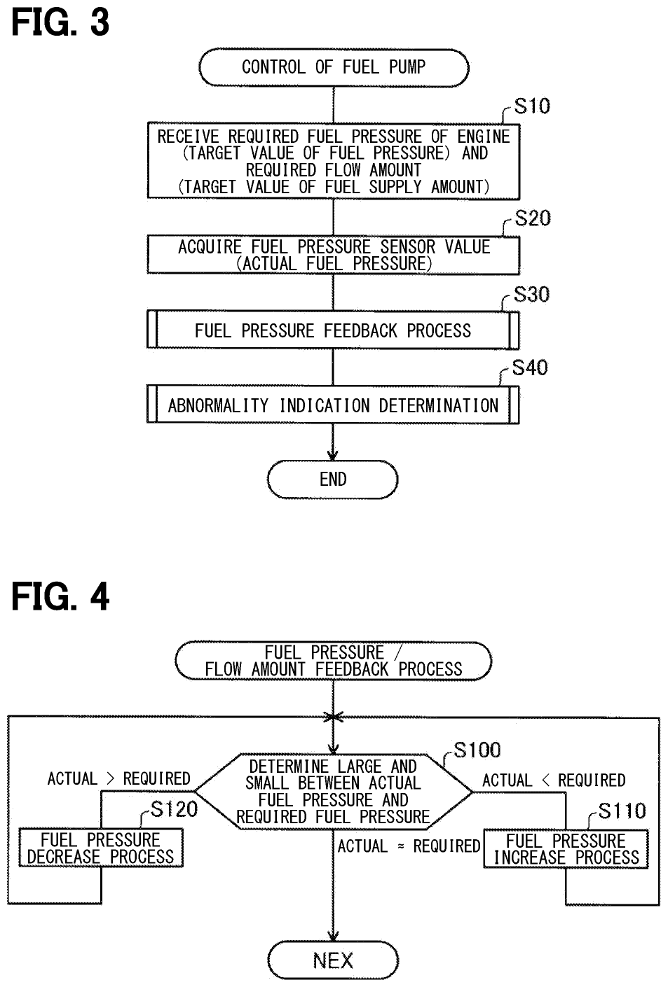

FIG. 3 shows a process repeatedly executed by the pump control unit 31 after the vehicle 10 is started. Note that the process may be executed by the control unit 40 instead of the pump control unit 31.

In step S10, the pump control unit 31 receives the required fuel pressure and the required flow amount calculated by the control unit 40. The pump control unit 31 controls the fuel pump 20 with the required fuel pressure as a control target value.

In step S20, the pump control unit 31 acquires the fuel pressure (actual fuel pressure) from the pressure sensor 17.

In step S30, the pump control unit 31 performs a feedback control so that the actual fuel pressure becomes the required fuel pressure. This fuel pressure feedback does not have to be performed on the fuel pressure, but a flow amount feedback may be performed on the flow amount as a parameter.

In step S40, the pump control unit 31 causes the fuel pump deterioration determination unit 35 to determine whether or not the fuel pump 20 shows an indication of an abnormality (also referred to as “a sign of an abnormality” or simply “a prediction”).

The feedback process will be described with reference to FIG. 4. In step S100, the pump control unit 31 determines a comparison result (large and small) between the actual fuel pressure and the required fuel pressure. The pump control unit 31 ends the feedback control when the actual fuel pressure substantially coincides with the required fuel pressure. In the case where the actual fuel pressure substantially coincides with the required fuel pressure, for example, the actual fuel pressure is within a predetermined range centered on the required fuel pressure. The predetermined range is, for example, a range of ±W [%] (W is, for example, a value of 5 or less) with respect to the target value. The predetermined range may be defined by an absolute value such as ±X [Pa] instead of the relative value of ±W [%].

In a case where the actual fuel pressure is less than the required fuel pressure, for example, where the actual fuel pressure is “target value×(100−W)/100” or less, the process proceeds to step S110 where the pump control unit 31 increases the fuel pressure. For example, the drive voltage (applied voltage) applied to the electric motor 21 or the drive current (supplied current) supplied to the electric motor 21 to drive the fuel pump 20 is increased, or the rotation speed of the fuel pump 20 is increased. Thereafter, the process returns to step S200. When the actual fuel pressure is larger than the required fuel pressure, for example, when the actual fuel pressure is “target value×(100+W)/100” or more, the process proceeds to step S120 where the pump control unit 31 executes a process to reduce the fuel pressure. For example, the drive voltage and drive current applied to the electric motor 21 that drives the fuel pump 20 is reduced, or the rotation speed of the fuel pump 20 is reduced. Thereafter, the process returns to step S200.

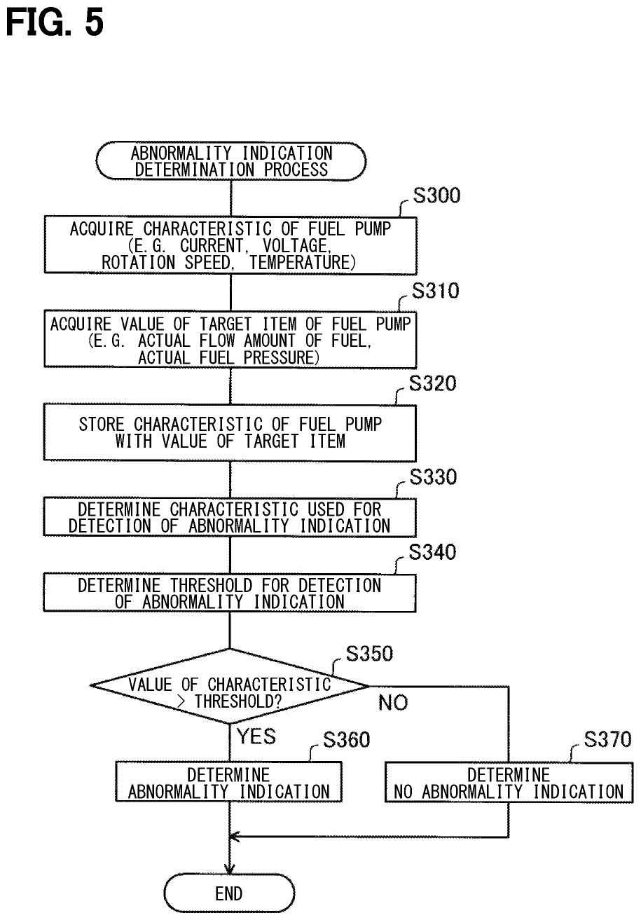

The process to determine the indication of an abnormality will be described with reference to FIG. 5. In step S300, the pump control unit 31 acquires a pump characteristic value that indicates the operating state of the fuel pump 20. In the present embodiment, the pump characteristic that indicates the operating state of the fuel pump 20 includes, for example, the supplied current to the electric motor 21, the applied voltage to the electric motor 21, the generated voltage, and the rotation speed of the fuel pump 20. The pump characteristic further includes a reflux time when a brushless motor switches the phase. The pump characteristic value that indicates the operating state of the fuel pump 20 may include the temperature of fuel.

In step S310, the pump control unit 31 acquires the control target value of a target item of the fuel pump 20. In the present embodiment, the target item represents “fuel flow amount” and “fuel pressure”, and the control target value of the target item is the control target value of the value of the fuel flow amount and the fuel pressure. By performing the feedback process, the target flow amount of the fuel, which is the control target value, is substantially the same as the actual flow amount, and the target fuel pressure, which is the control target value, is substantially the same as the actual fuel pressure. Therefore, the actual measured value may be used instead of the control target value. Further, the target item may include the supplied current to the electric motor 21, the applied voltage to the electric motor 21, the generated voltage of the electric motor 21, and the rotation speed of the fuel pump 20. Hereinafter, the supplied current and the applied voltage to the electric motor 21 are also referred to as “supplied current to the fuel pump 20” and “applied voltage to the fuel pump 20”, respectively, or simply “supplied current” and “applied voltage”, respectively.

In step S320, the pump control unit 31 stores the pump characteristic value that indicates the operating state of the fuel pump 20 in the pump characteristic storage unit 33 together with the control target value of the target item.

In step S330, the pump control unit 31 causes the determination threshold set unit 34 to determine the pump characteristic used for detecting the indication of an abnormality of the fuel pump 20. The pump characteristic used for detecting the indication of an abnormality of the fuel pump 20 may be predetermined. The item which may be used as the pump characteristic will be described later.

In step S340, the pump control unit 31 causes the determination threshold set unit 34 to set the determination threshold value for determining deterioration of the fuel pump 20. The determination threshold set unit 34 may have the determination threshold value for detecting the indication as a map in advance and may set the determination threshold value. Further, the determination threshold set unit 34 may compute a standard deviation of the pump characteristic value and an amount of variation in the pump characteristic value, which are stored in the pump characteristic storage unit 33, and may compute and set the determination threshold value using these standard deviation and the amount of variation.

In steps S350 to S370, the fuel pump control system unit 30 causes the fuel pump deterioration determination unit 35 to determine whether or not the fuel pump 20 has an indication of deterioration or abnormality using the pump characteristic value and the determination threshold value used for the detection of the indication.

In step S350, the fuel pump control system unit 30 causes the fuel pump deterioration determination unit 35 to determine whether or not the pump characteristic value used for predictive detection deviates from the determination threshold value. When the pump characteristic value deviates from the determination threshold value, the process proceeds to step S360. When the pump characteristic value does not deviate from the determination threshold value, the process proceeds to step S370. In step S360, the fuel pump deterioration determination unit 35 determines that an indication of an abnormality has occurred in the fuel pump 20. The fact that an indication of an abnormality of the fuel pump 20 has occurred is displayed on, for example, the instrument panel 46. In step S370, the fuel pump deterioration determination unit 35 determines that an indication of an abnormality has not occurred in the fuel pump 20.

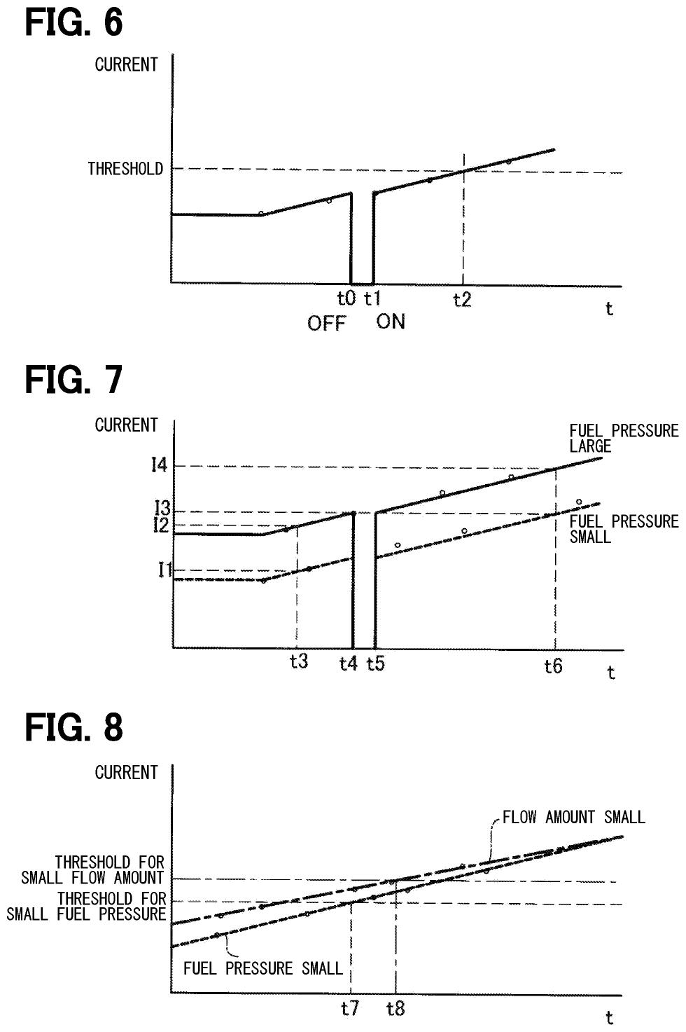

Hereinafter, the method of the fuel pump deterioration determination unit 35 to detect an indication of an abnormality of the fuel pump 20 will be described. In FIG. 6, the horizontal axis represents the usage time of the fuel pump 20, and the vertical axis represents the supplied current, which is one of the pump characteristics of the fuel pump 20. In the graph in FIG. 6 the supplied current to the fuel pump 20 stored in a small fuel pressure state is extracted from the stored supplied current to the fuel pump 20 and is plotted on the graph, and the points are connected to form a substantially straight line. For example, the supplied current in the state where the engine 18 is idling may be used as the supplied current in the small fuel pressure state. The idling state may occur, for example, when the vehicle 10 is waiting for a signal or immediately before the start switch 44 of the vehicle 10 is turned off. For example, the pump characteristic value when the vehicle 10 is waiting for a signal or the pump characteristic value immediately before the start switch 44 of the vehicle 10 is turned off may be used. For example, when the speed of the vehicle 10 becomes zero, and when a certain period of time elapses thereafter, it may be determined that the vehicle 10 is waiting for a signal. It is noted that, FIG. 6 is a graph in which the supplied current monotonically increases with the lapse of usage time in order to facilitate explanation of the indication of an abnormality of the fuel pump 20 in an easy-to-understand manner. However, the actual supplied current to the fuel pump 20 does not necessarily monotonically increase with the lapse of the usage time as shown in the graph of FIG. 6. Further, the current is zero from time t0 to time t1. This means that the engine 18 is turned off at time t0 and is turned on at time t1, and therefore, the supplied current during this period becomes zero.

In the example shown in FIG. 6, the value of the supplied current to the fuel pump 20 exceeds the determination threshold value at time t2. Therefore, the fuel pump deterioration determination unit 35 detects an indication of an abnormality of the fuel pump 20 at time t2. In the example of FIG. 6, the fuel pump deterioration determination unit 35 uses the supplied current to the fuel pump 20 when the fuel pressure is small. It is noted that, various pump characteristic values, such as the voltage and the pump rotation speed of the fuel pump 20 and the rotation speed increase time, may be used. In a case where the voltage is used, the applied voltage may be used. Further, the current of the fuel pump 20 when the fuel pressure is large, the voltage of the fuel pump 20, the pump rotation speed of the fuel pump 20, the rotation speed increase time of the fuel pump 20, and the rotation speed increase speed of the fuel pump 20 may be used. The rotation speed increase time means the time until the rotation speed increases by a certain amount when the voltage of the fuel pump 20 is increased by a certain amount, and the rotation speed increase speed means the increase speed at that time. For example, when the inertia of the fuel pump 20 is increased, the rotation speed increase time becomes longer, and the rotation speed increase speed becomes lower. The state where the fuel pressure is large may occur immediately after the start switch 44 is turned on, for example. Therefore, the pump characteristic value of the fuel pump 20 may be acquired immediately after the start switch 44 is turned on. Further, instead of the fuel pressure, the current of the fuel pump 20, the voltage of the fuel pump 20, and the pump rotation speed when the fuel flow amount is small or when the fuel flow amount is large may be used.

As described above, according to the present embodiment, the fuel pump deterioration determination unit 35 detects an indication of an abnormality in the fuel pump 20 by using the recorded pump characteristic value and the determination threshold value that is set to the value of the target item. Therefore, this configuration enables to detect an indication of an abnormality in the fuel pump 20 regardless of the usage status of the vehicle 10.

The fuel pump deterioration determination unit 35 may detect an indication of an abnormality in the fuel pump by using not only the pump characteristic value stored when the vehicle 10 (engine 18) is started or stopped but also the pump characteristic value stored in at least one state during the travel of the vehicle 10.

Hereinafter, examples of determination, which is made by the fuel pump deterioration determination unit 35 by using the determination threshold value that is set for a combination of two or more target item values, will be described. FIG. 7 shows one of the examples in which the fuel pump deterioration determination unit 35 detects an indication of an abnormality in the fuel pump 20 by using a correlation between the pump characteristic values stored for different control target values of the same target item. The different control target values of the same target item mean, for example, the control target value when the fuel pressure is large and the control target value when the fuel pressure is small. That is, in this example, the target item is the fuel pressure and is in common. However, the control target values of the target item stored in the pump characteristic storage unit 33 are different depending on whether the fuel pressure is large or small. In FIG. 7, two graphs, in which the supplied current to the fuel pump in the small fuel pressure state and the supplied current to the fuel pump in the large fuel pressure state, are shown. In this example, the fuel pump deterioration determination unit 35 detects an indication of an abnormality in the fuel pump 20 when a ratio between the supplied current to the fuel pump in the small fuel pressure state and the supplied current to the fuel pump in the large fuel pressure state exceeds the determination threshold value. In the example of FIG. 7, the ratio between the supplied current to the fuel pump 20 in the small fuel pressure state and the supplied current to the fuel pump 20 in the large fuel pressure state is I1/I2 or I3/I4. When the value of this ratio exceeds the determination threshold value, the fuel pump deterioration determination unit 35 detects that an indication of an abnormality of the fuel pump 20 arises. In the example shown in FIG. 7, at time t3, I1/I2 does not exceed the determination threshold value, and at time t6, I3/I4 exceeds the determination threshold value. In this case, it is determined that an indication of an abnormality in the fuel pump 20 has occurred at time t2. It is noted that, in the period between time t4 and t5, the engine 18 is turned off at time t4 and is turned on at time t5, and this means that the current during this period becomes zero.

As described above, according to this embodiment, the fuel pump deterioration determination unit 35 detects the indication of the fuel pump 20 as described above by using the correlation of the pump characteristic values stored for the different control target values of the same target item, such as the control target value when the fuel pressure is large and the control target value when the fuel pressure is small. Therefore, this configuration enables more accurate detection of the indication.

FIG. 8 is an example in which the fuel pump deterioration determination unit 35 detects an indication of an abnormality in the fuel pump 20 by using the pump characteristic values stored for the values of different target items, respectively. The different control target values of the different target items mean, for example, the control target value when the fuel pressure is small and the control target value when the fuel flow amount is small. The target items that are the fuel pressure and the fuel flow amount and are different from each other. In FIG. 8, two graphs, in which the supplied current to the fuel pump 20 in the small fuel pressure state and the supplied current to the fuel pump 20 in the small fuel flow amount state, are shown. In the small fuel pressure state, the supplied current to the fuel pump 20 exceeds the determination threshold value at time t7. In the small fuel flow amount state, the supplied current to the fuel pump 20 exceeds the determination threshold value at time t8, which is later than time t7. In this case, the fuel pump deterioration determination unit 35 detects that an indication of an abnormality of the fuel pump 20 arises at time t8 at which the supplied current to the fuel pump 20 in the small fuel pressure state exceeds the determination threshold value, and the supplied current to the fuel pump 20 in the small fuel flow amount state exceeds the determination threshold value. In the example shown in FIG. 8, the fuel pump deterioration determination unit 35 uses the supplied current to the fuel pump 20 in the small fuel pressure state and the supplied current to the fuel pump 20 in the small fuel flow amount state. It is noted that, the supplied current to the fuel pump 20 in a large fuel pressure state and the supplied current to the fuel pump 20 in a large fuel flow amount state may be used. Further, the fuel pump deterioration determination unit 35 may use the applied voltage, the pump rotation speed, or the like of the fuel pump 20 instead of the current of the fuel pump 20. FIG. 8 shows the example in which a period, where the engine 18 is turned off, does not reside. It is noted that, a period, where the engine 18 is turned off, may reside similarly to the example as shown in FIGS. 6 and 7.

As described above, according to this embodiment, the fuel pump deterioration determination unit 35 detects the indication in the fuel pump 20 by using the pump characteristic values stored for the control target values of the different target items, respectively, such as the control target value when the fuel pressure is small and the control target value when the fuel flow amount is small. Therefore, this configuration enables more accurate detection of the indication.

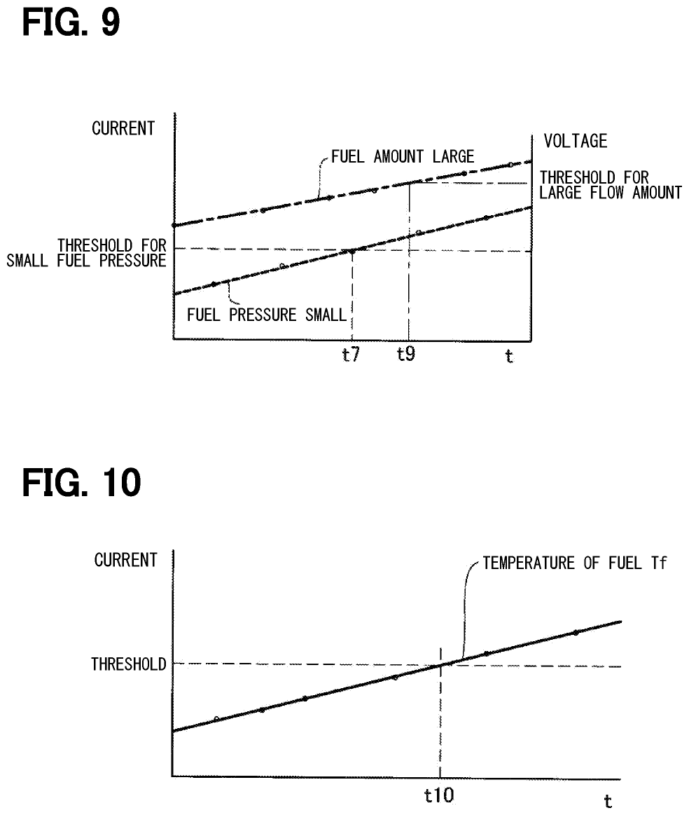

FIG. 9 shows another of the examples in which the fuel pump deterioration determination unit 35 detects an indication of an abnormality in the fuel pump 20 by using different pump characteristic values stored for different control target values of different target items. The different control target values of the different target items mean, for example, the control target value when the fuel pressure is small and the control target value when the fuel flow amount is large. The target items that are the fuel pressure and the fuel flow amount and are different from each other. When the fuel pressure is small, the fuel flow amount is small, and conversely, when the fuel pressure is large, the fuel flow amount is large. Therefore, the control target value when the fuel pressure is small and the control target value when the fuel flow amount is large are different from each other. The different pump characteristics mean, for example, that the sensors that acquire the pump characteristics are different from each other, and that the current and the voltage are different pump characteristics, respectively. In FIG. 8, two graphs, in which the supplied current to the fuel pump 20 in the small fuel pressure state and the applied voltage to the fuel pump 20 in the large fuel flow amount state, are shown. In the small fuel pressure state, the supplied current to the fuel pump 20 exceeds the determination threshold value at time t7. In the large fuel flow amount state, the applied voltage to the fuel pump 20 exceeds the determination threshold value at time t9, which is later than time t7. In this case, the fuel pump deterioration determination unit 35 detects that an indication of an abnormality of the fuel pump 20 arises at time t9 at which the supplied current to the fuel pump 20 in the small fuel pressure state exceeds the determination threshold value, and the applied voltage to the fuel pump 20 in the large fuel flow amount state exceeds the determination threshold value. In the example shown in FIG. 9, the fuel pump deterioration determination unit 35 uses the supplied current to the fuel pump 20 in the small fuel pressure state and the applied voltage to the fuel pump 20 in the large fuel flow amount state. It is noted that, the applied voltage to the fuel pump 20 in a large fuel pressure state and the supplied current to the fuel pump 20 in a small fuel flow amount state may be used. FIG. 9 shows the example in which a period, where the engine 18 is turned off, does not reside. It is noted that, a period, where the engine 18 is turned off, may reside similarly to the example as shown in FIGS. 6 and 7.

As described above, according to this embodiment, the fuel pump deterioration determination unit 35 detects an indication of an abnormality in the fuel pump 20 by using the different pump characteristic values that are stored for the different control target values of the different target items, respectively, such as the value when the fuel pressure is small and the value when the fuel flow amount is large. Therefore, this configuration enables more accurate detection of the indication.

FIG. 10 is an example in which the fuel pump deterioration determination unit 35 detects an indication of an abnormality in the fuel pump 20 by using the pump characteristic value stored for the fuel temperature. FIG. 10 shows the supplied current to the fuel pump 20 when the fuel pressure is small and when the fuel temperature is Tf. In the example shown in FIG. 10, the value of the supplied current to the fuel pump 20 exceeds the determination threshold value at time t10. Therefore, the fuel pump deterioration determination unit 35 detects an indication of an abnormality of the fuel pump 20 at time t10. In the examples shown in FIGS. 6 to 9, the fuel pump deterioration determination unit 35 may detect an indication of an abnormality in the fuel pump 20 by using the pump characteristic value stored for the fuel temperature. FIG. 10 shows the example in which a period, where the engine 18 is turned off, does not reside. It is noted that, a period, where the engine 18 is turned off, may reside similarly to the example as shown in FIGS. 6 and 7.

As described above, according to this embodiment, the fuel pump deterioration determination unit 35 enables to detect an indication of an abnormality in the fuel pump 20 by selecting a pump characteristic value that facilitates detection of the indication according to the traveling condition of the vehicle 10.

In the above embodiments, the fuel pump deterioration determination unit 35 uses the pump characteristic values that increase when an indication of an abnormality occur in the fuel pump 20 and the correlations therebetween. It is noted that a pump characteristic value that decreases when an indication of an abnormality occurs in the fuel pump 20 and the correlations therebetween may be used. In this case, those graphs corresponding to FIGS. 6 to 10 exhibit downward-inclinations, respectively, and the fuel pump deterioration determination unit 35 detects an indication of an abnormality in the fuel pump 20 when the values fall below the determination threshold values, respectively.

In the above embodiments, the fuel pump deterioration determination unit 35 provided in the fuel pump control system unit 30 detects an indication of an abnormality in the fuel pump 20. It is noted that, an indication of an abnormality in the fuel pump 20 may be detected by using the control unit 40 or by using a fuel pump deterioration determination unit that is provided separately from the fuel pump control system unit 30 and the control unit 40.

The present disclosure may be realized as the following embodiments.

According to one embodiment of the present disclosure, a fuel pump control system for supplying fuel from a fuel tank (12) to an internal combustion engine (18) is provided. This fuel pump control system includes: a pump control unit (30) configured to control the fuel pump based on a control target value of at least one target item of the internal combustion engine; a pump characteristic detection unit (32) configured to acquire a pump characteristic value, which is required to determine deterioration of the fuel pump, among pump characteristic values, which indicate an operating state of the fuel pump and include a supplied current to the fuel pump, an applied voltage to the fuel pump, a generated voltage of the fuel pump, and a rotation speed of the fuel pump; a pump characteristic storage unit (33) configured to store the pump characteristic value acquired by the pump characteristic detection unit together with the control target value; a determination threshold set unit (34) configured to set a determination threshold value, which is for determining deterioration of the fuel pump, by using at least one of the stored pump characteristic value, the control target value, and a combination of at least two of the control target values; and a fuel pump deterioration determination unit (35) configured to determine deterioration of the fuel pump by using the pump characteristic value stored in the pump characteristic storage unit and the determination threshold value. This configuration detects an indication of an abnormality in the fuel pump when the pump characteristic value of the fuel pump exceeds the determination threshold value that is set for the control target value of the target item. Therefore, even in a case where the control target value of the target item changes depending on the usage and the condition of the vehicle, an indication of an abnormality in fuel pump can be detected.

In the above embodiments, the fuel pump deterioration determination unit may detect an indication of an abnormality in the fuel pump by using the correlation between the pump characteristic values stored for different control target values of the same target item. This configuration detects an indication of an abnormality in the fuel pump by using the correlation between the pump characteristic values stored for different control target values of the same target item. Therefore, this configuration enables to detect an indication of an abnormality in the fuel pump with higher accuracy.

In the above embodiments, the fuel pump deterioration determination unit may detect an indication of an abnormality in the fuel pump by using the pump characteristic values stored for the control target values of the different target items, respectively. This configuration detects an indication of an abnormality in the fuel pump by using the pump characteristic values stored for the control target values of the different target items, respectively. Therefore, this configuration enables to detect an indication of an abnormality in the fuel pump with higher accuracy.

In the above embodiments, the fuel pump deterioration determination unit may detect an indication of an abnormality in the fuel pump by using the different pump characteristic values stored for the different control target values of the different target items, respectively. This configuration detects an indication of an abnormality in the fuel pump by using the different pump characteristic values stored for the different control target values of the different target items, respectively. Therefore, this configuration enables to detect an indication of an abnormality in the fuel pump with higher accuracy.

In the above embodiment, the fuel temperature sensor 19 configured to acquire the fuel temperature may be further provided. The pump characteristic storage unit may be further configured to store the pump characteristic value and the fuel temperature together with the control target value. The fuel pump deterioration determination unit may be further configured to detect an indication of an abnormality of the fuel pump by using the pump characteristic value stored for the control target value and the fuel temperature according to a traveling condition of the vehicle that is provided with the fuel pump. According to this embodiment, the fuel pump deterioration determination unit enables to detect an indication of an abnormality in the fuel pump by selecting a pump characteristic value that facilitates detection of the indication according to the traveling condition of the vehicle.

In the above embodiments, the fuel pump deterioration determination unit may be further configured to detect an indication of an abnormality of the fuel pump by using, as the target item, at least one of the fuel flow amount, the fuel pressure, the rotation speed of the fuel pump, the applied voltage to the pump, and the generated voltage. According to this embodiment, the fuel pump deterioration determination unit uses, as the target item, at least one of the fuel flow amount, the fuel pressure, the rotation speed of the fuel pump, the applied voltage to the pump, and the generated voltage. Therefore, this configuration facilitates detection of an indication of an abnormality in the fuel pump without depending on an external environment.

In the above embodiment, the pump control unit may be further configured to detect an indication of an abnormality of the fuel pump by using the pump characteristic value stored in at least one of a state where the internal combustion engine is started, a state where the internal combustion engine is stopped, or a state where the internal combustion engine is in operation. The state, in which the internal combustion engine is started or stopped, surely occurs. Therefore, this configuration enables to surely acquire the pump characteristic value. In addition, at the time of starting, the fuel flow amount is large, and the fuel pressure is large. On the other hand, at the time of stopping, the engine is normally in the idling state, and therefore, the fuel flow amount is small, and the fuel pressure is small. Therefore, this configuration enables to facilitate acquisition of the pump characteristic values for different control target values in a stable manner.

It should be noted that the present disclosure may be realized in various forms. For example, the present disclosure may be realized in a form of the fuel pump control system and may be in a form of a fuel pump control device, a method for detecting an indication of an abnormality of the fuel pump, or the like.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

What is claimed is:

1. A fuel pump control system comprising:
a fuel pump configured to supply fuel from a fuel tank to an internal combustion engine;
a pump control unit configured to control the fuel pump based on a control target value of at least one target item of the internal combustion engine;
a pump characteristic detection unit configured to acquire a pump characteristic value, which is required to determine deterioration of the fuel pump, among pump characteristic values, which indicate an operating state of the fuel pump and include a supplied current to the fuel pump, an applied voltage to the fuel pump, a generated voltage of the fuel pump, and a rotation speed of the fuel pump;
a pump characteristic storage unit configured to store, together with the control target value, the pump characteristic value acquired by the pump characteristic detection unit;
a determination threshold set unit configured to set a determination threshold value, which is for determining deterioration of the fuel pump, by using at least one of the stored pump characteristic value, the control target value, and a combination of at least two of the control target values; and
a fuel pump deterioration determination unit configured to determine deterioration of the fuel pump by using the pump characteristic value stored in the pump characteristic storage unit and the determination threshold value.

2. The fuel pump control system according to claim 1, wherein
the fuel pump deterioration determination unit is configured to detect an indication of an abnormality in the fuel pump by using a correlation between the pump characteristic values stored for different control target values of the same target item.

3. The fuel pump control system according to claim 1, wherein
the fuel pump deterioration determination unit is configured to detect an indication of an abnormality in the fuel pump by using the pump characteristic values stored for the control target values of the different target items, respectively.

4. The fuel pump control system according to claim 3, wherein
the fuel pump deterioration determination unit is configured to detect an indication of an abnormality in the fuel pump by using the different pump characteristic values stored for the different control target values of the different target items, respectively.

5. The fuel pump control system according to claim 1, further comprising:
a temperature sensor configured to acquire a fuel temperature, wherein
the pump characteristic storage unit is configured to store, together with the control target value, the pump characteristic value and the fuel temperature, and
the fuel pump deterioration determination unit is configured to detect an indication of an abnormality of the fuel pump by using the pump characteristic value stored for the control target value and the fuel temperature according to a traveling condition of a vehicle that is provided with the fuel pump.

6. The fuel pump control system according to claim 1, wherein
the fuel pump deterioration determination unit is configured to detect an indication of an abnormality of the fuel pump by using, as the target item, at least one of a fuel flow amount, a fuel pressure, a rotation speed of the fuel pump, the applied voltage to the fuel pump, and the generated voltage.

7. The fuel pump control system according to claim 1, wherein
the fuel pump deterioration determination unit is configured to detect an indication of an abnormality of the fuel pump by using the pump characteristic value stored in at least one of a state where the internal combustion engine is started, a state where the internal combustion engine is stopped, or a state where the internal combustion engine is in operation.

8. A fuel pump control system configured to drive a fuel pump that is configured to supply fuel from a fuel tank to an internal combustion engine, comprising:
a pump control unit configured to control the fuel pump based on a control target value of at least one target item of the internal combustion engine;
a pump characteristic detection unit configured to acquire a pump characteristic value, which is required to determine deterioration of the fuel pump, among pump characteristic values, which indicate an operating state of the fuel pump and include a supplied current to the fuel pump, an applied voltage to the fuel pump, a generated voltage of the fuel pump, and a rotation speed of the fuel pump;
a pump characteristic storage unit configured to store, together with the control target value, the pump characteristic value acquired by the pump characteristic detection unit;
a determination threshold set unit configured to set a determination threshold value, which is for determining deterioration of the fuel pump, by using at least one of the stored pump characteristic value, the control target value, and a combination of at least two of the control target values; and
a fuel pump deterioration determination unit configured to determine deterioration of the fuel pump by using the pump characteristic value stored in the pump characteristic storage unit and the determination threshold value.

9. A method for detecting an indication of an abnormality in a fuel pump that is configured to supply fuel from a fuel tank to an internal combustion engine, comprising:
controlling the fuel pump based on a control target value of at least one target item of the internal combustion engine;
acquiring a pump characteristic value, which is required to determine deterioration of the fuel pump, among pump characteristic values, which indicate an operating state of the fuel pump and include a supplied current to the fuel pump, an applied voltage to the fuel pump, a generated voltage of the fuel pump, and a rotation speed of the fuel pump;
storing, together with a value of the target item, the acquired pump characteristic value;
setting a determination threshold value, which is for determining deterioration of the fuel pump, by using at least one of the stored pump characteristic value, the control target value, and a combination of at least two of the control target values; and
determining deterioration of the fuel pump by using the stored pump characteristic value and the determination threshold value.

10. The fuel pump control system according to claim 1, further comprising:
at least one processor configured to implement functions of the pump control unit, the pump characteristic detection unit, the pump characteristic storage unit, the determination threshold set unit, and the fuel pump deterioration determination unit.

11. The fuel pump control system according to claim 8, further comprising:
at least one processor configured to implement functions of the pump control unit, the pump characteristic detection unit, the pump characteristic storage unit, the determination threshold set unit, and the fuel pump deterioration determination unit.

12. The method according to claim 9, wherein
the controlling, the acquiring, the storing, the setting, and the determining are processes executed by at least one processor.
